(19) United States
(12) Patent Application Publication
(10) Pub. No.: US 2013/0135878 A1
(43) Pub. Date: May 30, 2013

(54) ADJUSTABLE LIGHT CASING

(71) Applicant: Tsui-Yun WONG, Taipei City (TW)

(72) Inventor: Tsui-Yun WONG, Taipei City (TW)

(21) Appl. No.: 13/304,842

(22) Filed: Nov. 28, 2011

(51) Int. Cl. F21V 21/00

(52) U.S. Cl. 362/368; 362/374

(57) ABSTRACT

A adjustable light casing comprises: an inner case, the wall surface of which being a half-arc surface, a surface corresponding to the half-arc surface being an opened surface, plural closed rings being disposed two ends of the inner case; an outer case, the wall surface of which being a half-arc surface, a surface corresponding to the half-arc surface being an opened surface, plural closed rings being disposed at the two ends of the outer case; and plural lateral fastening members, each lateral fastening member having an inner ring structure and an outer ring structure.

### BACKGROUND OF THE INVENTION

1. Field of the Invention

The present invention, generally, relates to a adjustable light casing that is disposed on walls, beneath draining tubes or under eaves. Functions include user customization of the device's opening and closing feature pending on varying occasions and situations.

2. Description of the Prior Art

Traditional, decorative lights are installed for holidays and occasions such as Christmas, the Fourth of July, Halloween, etc. . . . The repetitive cycle of buying, unloading, installing, breaking down, packaging, and storing these festive lights can be an exhaustive process on any family. Furthermore, there is a constant exposure to risk of injury each time these lights need to be installed. In essence, there is a huge amount of risk, effort, money, and time invested into the installation of outdoor, decorative lights.

The aforementioned problems with outdoor, decorative light installations have plagued households for a long time. As a result, the best solution would be a permanent and discreet light installation that would be entirely customizable in accordance to respective holidays and festivals. Furthermore, the adjustable light would allow users to open and close the structure in order to hide the appearance of the lights until the next, desired usage period.

Further, the applicant of the present invention has applied a U.S. patent Ser. No. 13/208,402, on Aug. 12, 2011.

### SUMMARY OF THE INVENTION

The main objective of the present invention is to provide a adjustable light casing that can be varied with different holidays or user demands, and does not require constant assembly and disassembly.

The second objective of the present invention is to provide a adjustable light casing that requires easy installment and simplistic usage.

The third objective of the present invention is to provide a adjustable light casing that has different types of connections such as direct connections and angled connections. These installments will accommodate houses with different categories, dimensions and structures.

To approach the above objectives, the adjustable light casing comprises: an inner case, the wall surface of the inner case being a half-arc surface, a surface corresponding to the half-arc surface being an opened surface, a plurality of closed rings being disposed at two ends of the inner case; an outer case, the wall surface of the inner case being a half-arc surface, a surface corresponding to the half-arc surface being an opened surface, a plurality of closed rings being disposed at the two ends of the outer case; and a plurality of lateral fastening members, each lateral fastening member having an inner ring structure and an outer ring structure; wherein the closed rings at the two ends of the inner case are fastened to the inner ring structures of the lateral fastening members and the rings at the two ends of the outer case are movably female-connected with the outer ring structures of the lateral fastening members, the opened surface of the inner case being shielded or opened by the half-arc surface of the outer case while the inner case is turned upwardly.

For a preferred embodiment the inner surface of the inner case is disposed at least one lamp-string fixing structure that is to position at least light emitting element.

For a preferred embodiment, each of the ends of the inner case has a fastening hole, the inner ring structure of the lateral fastening member has a fastening hole corresponding to the fastening hole, the fastening holes of the inner case corresponds to a fastening hole the inner ring structures of the lateral fastening member and the inner case being female-connected with the inner ring structure through a plurality of bolts while the inner case and the inner ring structures of the lateral fastening members are combined together.

For a preferred embodiment, the outer ring structure of the lateral fastening member has a stop portion, the location of the inner side of the outer case corresponding to the stop portion has at least one protruding structure in order to let the outer case be female-connected with and slid on the outer ring structure, the lifting of the outer case being stopped while the protruding structure reaches the stop portion.

Further, To approach above objectives, the adjustable light casing comprises: a plurality of lateral fastening members, each lateral fastening member having an inner ring structure and an outer ring structure, a plurality of screw structures being internally disposed in the lateral fastening member; an inner case, the wall surface of the inner case being a half-arc surface, a surface corresponding to the half-arc surface being an opened surface, a plurality of closed rings being disposed two ends of the inner case; an outer case, the wall surface of the inner case being a half-arc surface, a surface corresponding to the half-arc surface being an opened surface, a plurality of closed rings being disposed at the two ends of the outer case; and a plurality of case-fastening members, which are fastened to the screw structures of the lateral fastening members, so that the case-fastening members are fastened to a roof, ceiling or wall.

For a preferred embodiment, the case-fastening member comprises a plurality of parts: positioning bases, screw pillars and nuts, the positioning base being constructed by a bottom plate and a stand plate that are perpendicular to each other, wherein the stand plate has a through hole, the screw pillar being through the through hole of the stand plate of the positioning base and then screwed into the screw structure of the lateral fastening member, the nut and the screw pillar being then screwed together in order to bond the positioning base, the lateral fastening member and the inner case together.

For a preferred embodiment, the bottom plate of the positioning base has at least one connecting hole, the bottom plate of the positioning base being fastened to the roof, ceiling or wall while at least one bolt is through the connecting hole of the bottom plate.

For a preferred embodiment, the positioning base has at least one positioning hole corresponding to one side of the lateral fastening member, the location of the lateral fastening member corresponding to the positioning hole of the positioning base being disposed at least one positioning hole, the opened surface of the inner case being toward an irradiation surface through that an inserting rod is inserted into the positioning base and the positioning hole of the lateral fastening member.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1A illustrates a schematic 3-D exploded view of the adjustable light casing of the present invention;

FIG. 1B illustrates a schematic assemble view of the adjustable light casing of the present invention;

FIG. 2 illustrates a schematic structural view of an inner case of the adjustable light casing of the present invention;

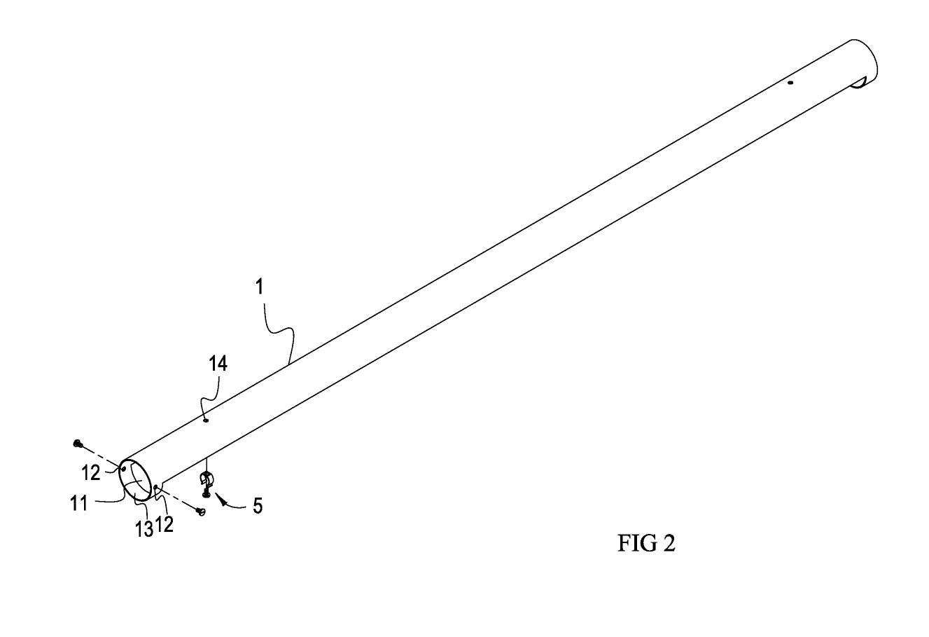

FIG. 3A illustrates a schematic structural view of an outer case of the adjustable light casing of the present invention;

FIG. 3B illustrates a schematic lateral view of the outer case of the adjustable light casing of the present invention;

FIG. 4A illustrates a schematic structural view of a lateral fastening member of the adjustable light casing of the present invention;

FIG. 4B illustrates a schematic lateral view of the lateral fastening member of the adjustable light casing of the present invention;

FIG. 5 illustrates a schematic lateral view of combining the inner case and the outer case of the adjustable light casing of the present invention;

FIG. 6A illustrates a schematic view of a half-opened status of the inner case of the adjustable light casing of the present invention;

FIG. 6B illustrates a schematic view of a full-opened status of the inner case of the adjustable light casing of the present invention; and

FIG. 7 illustrates a schematic application view of the adjustable light casing of the present invention.

### DETAILED DESCRIPTION OF THE INVENTION

Following preferred embodiments and figures will be described in detail so as to achieve aforesaid objects.

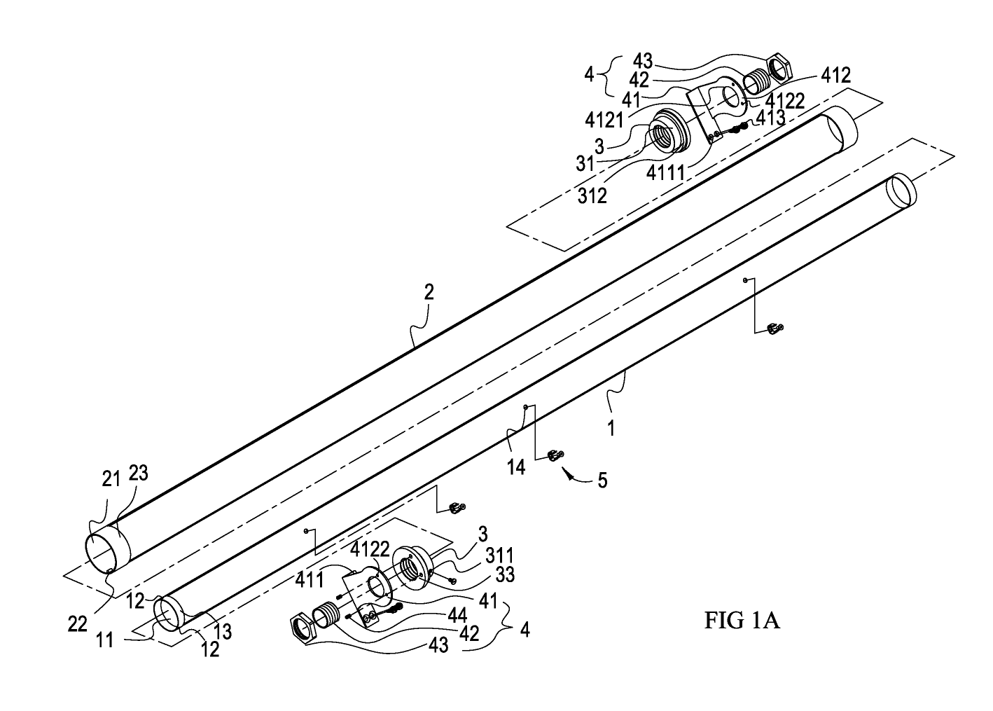

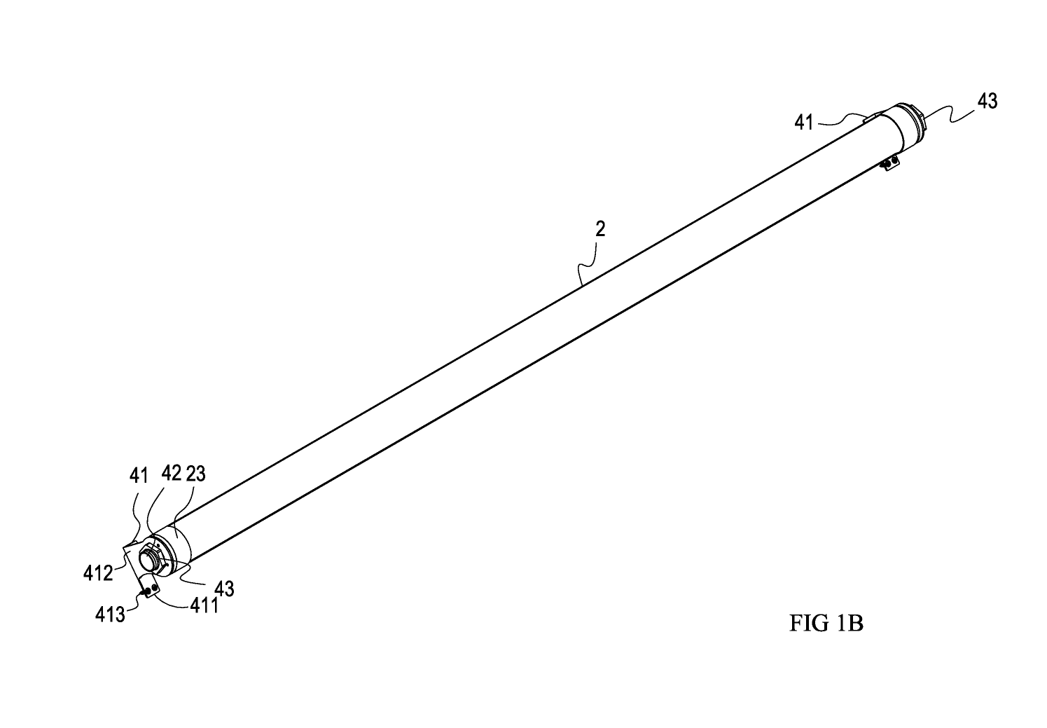

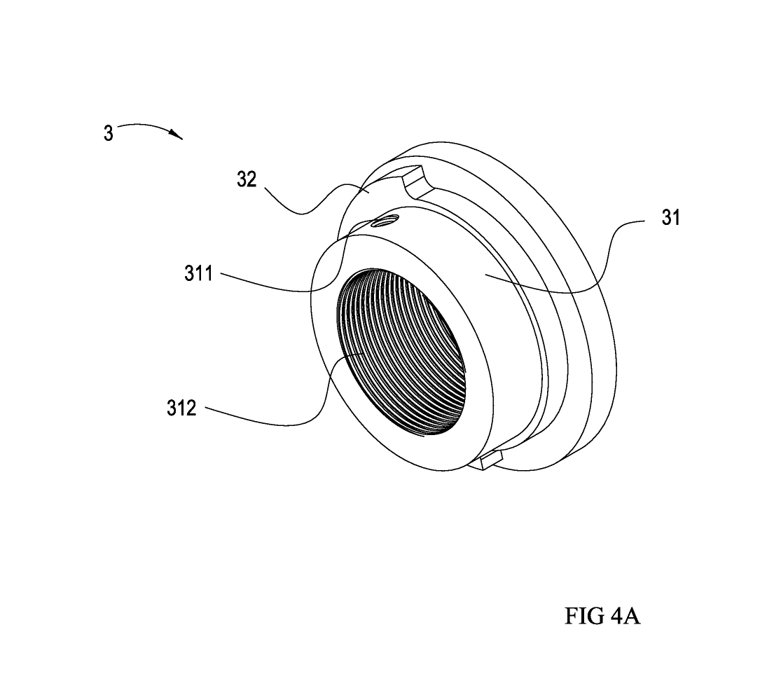

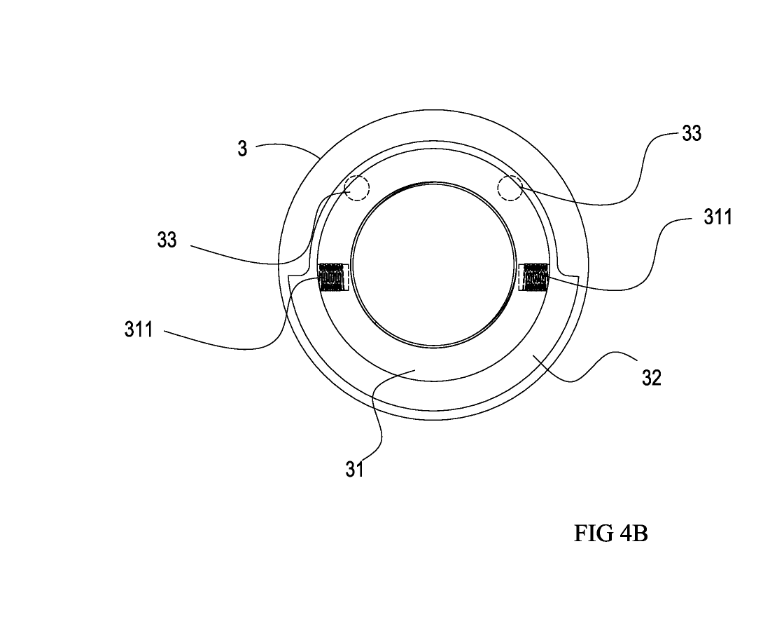

With references to FIG. 1A and FIG. 1B, which illustrate a schematic 3-D exploded view of the adjustable light casing of the present invention and a schematic assemble view of the adjustable light casing of the present invention. As shown in figures, the adjustable light casing includes an inner case (1), an outer case (2), two lateral fastening members (3), and at least one case-fastening member (4), both the wall surfaces of the inner case (1) and the outer case (2) are about half-arc surfaces, hence each surface corresponding to each of the half-arc surface is an opened surface in order that each section of the inner case (1) and the outer case (2) is approximately shaped as C-type, the two ends of the inner case (1) and the two ends of the outer case (2) are disposed plural closed rings (13) and plural closed rings (23), and plural opens (11) and plural opens (21) are formed by such closed rings (13) and (23), continuously, as shown in FIG. 4A, the lateral fastening member (3) includes an inner ring structure (31) and an outer ring structure (32), thus each open (11). of the two ends of the inner case (1) can be female-connected with the inner ring structure (31), the outer side of the inner case (1) is disposed a fastening hole (12) corresponding to the inner ring structure (31), the location of the inner ring structure (31) corresponding to the fastening hole (12) of the surface of the inner case (1) is disposed at least one fastening hole (311), so that the inner case (1) is female-connected with the inner ring structure (31) through a plurality of bolts (413) being screwed into the fastening holes (12) and (311) of the inner case (1) and the inner ring structure (31), thus the two ends of the inner case (1) are fastened to the inner ring structures (31), the opens (21) of the two ends of the outer case (2) are female-connected with the outer ring structures (32), therefore the outer case (2) is female-connected with the outside of the inner case (1) in order to let the inner case (1) be turned.

Since the two ends of the inner case (1) are fastened to the inner ring structures (31) of the lateral fastening members (3), the outer case (2) is then female-connected with the outside of the inner case (1), and the two lateral fastening members (3) are connected with the opens (11) and (21) of the inner case (1) and the outer case (2) respectively, therefore the inner case (1) and the outer case (2) are positioned, and the outer case (2) is able to be withdrawn along the inner case (1) for exposing the inner space of the inner case (1); similarly, the withdrawn outer case (2) can be re-combined with the inner case (1) along the inner case (1) so as to form a closed space.

Further, the inner surface of the inner case (1) is disposed at least one lamp-string fixing structure (5) that is fastened in a fastening hole (14) of the inner side of the inner case (1) in order that a light emitting element can be placed into the inner case (1).

For the adjustable light casing being fastened to a roof or wall, the case-fastening members (4) are the key role, and each of the case-fastening members (4) includes a plurality of positioning bases (41), screw pillars (42) and nuts (43), the positioning base (41) being constructed by a bottom plate (411) and a stand plate (412) that are perpendicular to each other, wherein the bottom plate (411) has at least one connecting hole (4111) and the stand plate (412) has a through hole (4121), the screw pillar (42) is through the through hole (4121) of the stand plate (412) of the positioning base (41) and then screwed into the screw structure (312) of the lateral fastening member (3), the nut (43) and the screw pillar (42) are then screwed together in order to bond the positioning base (41), the lateral fastening member (3) and the inner case (1) together, more, by way of the bolts (413) or other fasteners going through the connecting holes (4111) of the bottom plate (411) is able to fasten the bottom plate (411) of the positioning base (41) to a roof, ceiling or wall.

Additionally, the positioning base (41) has at least one positioning hole (4122) corresponding to one side of the lateral fastening member (3), the location of the lateral fastening member (3) corresponding to the positioning hole (4122) of the positioning base (41) being disposed at least one positioning hole (33), through that an inserting rod (44) is inserted into the positioning base (41) and the positioning hole (33) of the lateral fastening member (3), two corresponding position of the half-opened structure of the inner case (1) and the bottom plate (411) of positioning base (41) are thus defined, and a half-opened structure of the inner case (1) is toward an irradiation surface for illumination when the bottom plate (411) of positioning base (41) is fastened to a roof, ceiling or wall.

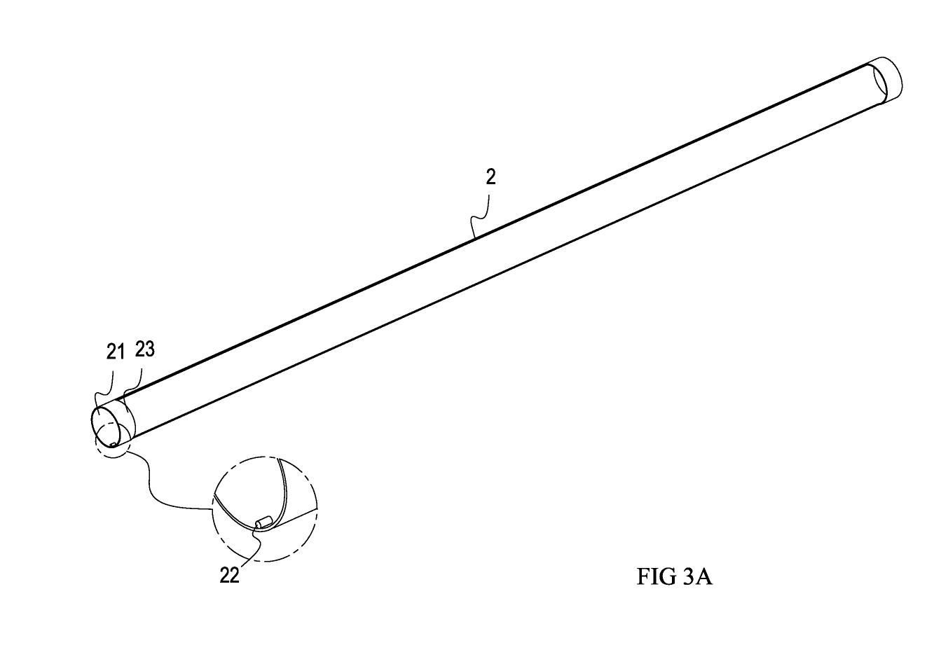

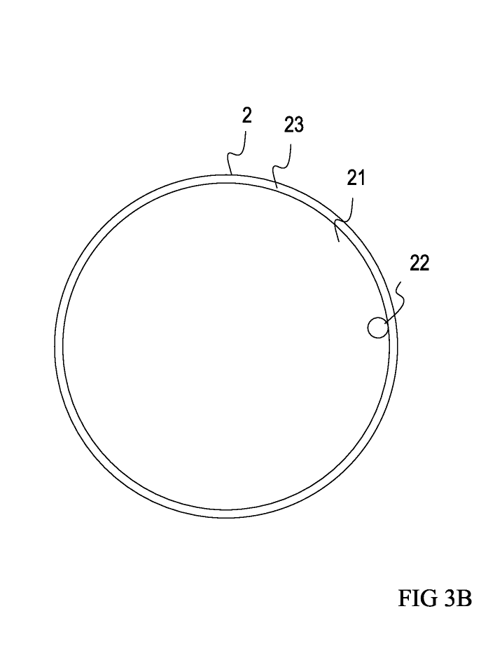

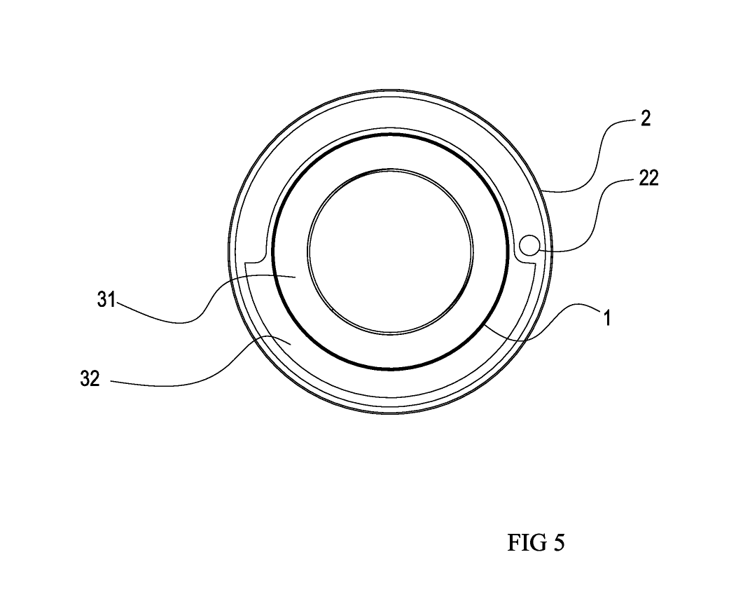

With references to FIG. 1A, FIG. 3A and FIG. 4A, the outer ring structure (32) has a stop portion, the location of the inner side of the outer case (2) corresponding to the stop portion has at least one protruding structure (22) in order to let the outer case (2) be female-connected with and slid on the outer ring structure (32), as shown in FIG. 5, the protruding structure (22) of the outer case (2) slides on the outer case (32), the lifting/withdrawal of the outer case (2) is stopped in order to limit the turning position of the outer case (2) while the protruding structure (22) touches the stop portion, hence, the half-opened structure of the inner case (1) can be precisely opened or closed by the outer case (2).

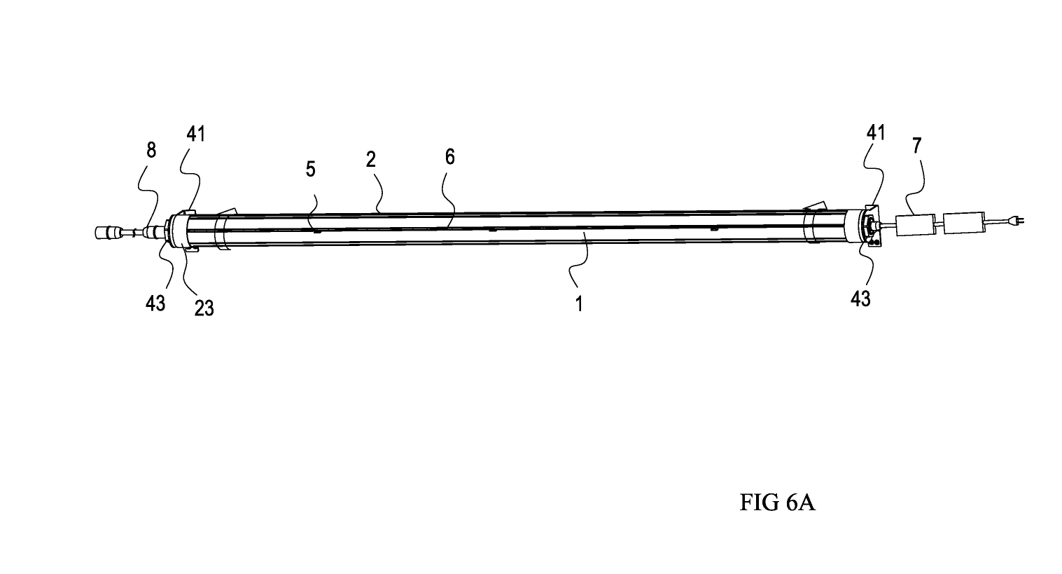

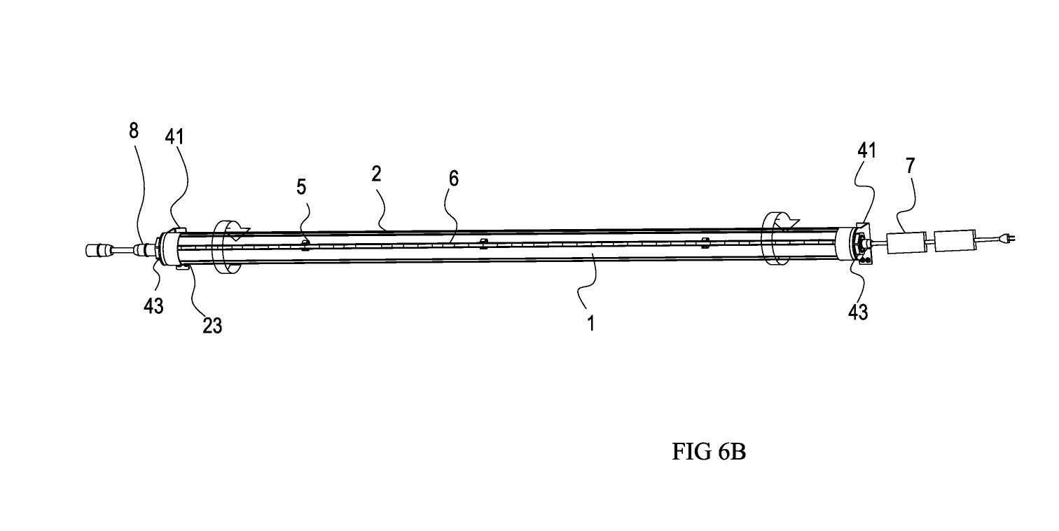

A plurality of light emitting elements (6) are disposed at the inner side of the inner case (1) of the adjustable light casing. Such that, the outer case (2) is able to be withdrawn along the inner case (1) for exposing the plurality of light emitting elements (6) of the inner case (1), as shown in FIG. 6A and FIG. 6B, FIG. 6A is a half-opened status of the inner case (1), FIG. 6B is a full-opened status; similarly, the withdrawn outer case (2) can be closed inwardly along the inner case (1), and the half-arc surface of the outer case (2) closes the opened surface of the inner case (1), as shown in FIG. 1B.

The aforementioned light emitting element can be decorative light, Christmas light, neon light, LED string light, or fluorescent string; for such light emitting elements, the inner surface of the inner case (1) is disposed a plurality of lamp-string fixing structures (5) that are to position the light emitting elements.

To connect the light emitting elements (6) with a power source, one end of the adjustable light casing is added a power line (7), the light emitting elements (6) are electrically connected with the power line (7) for providing electrical power; another end of the adjustable light casing can be further added via connector (8), and connector (8) is able to connect with the light emitting elements (6). This, thereby, allows the connection of several adjustable light casings while still maintaining the power source for all light emitting elements.

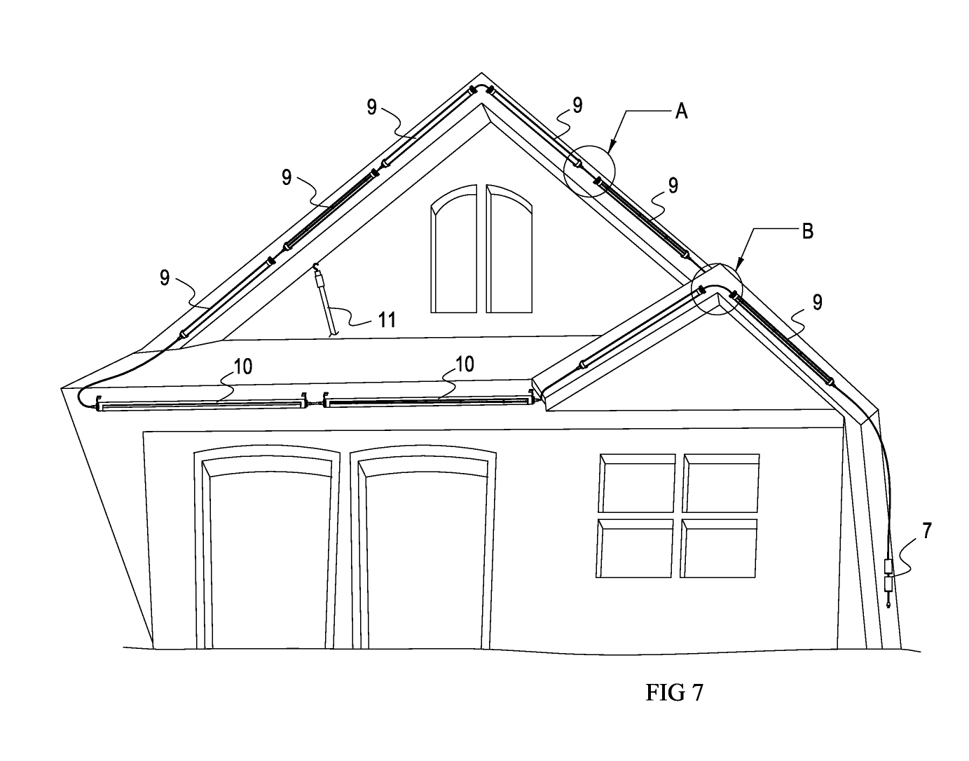

The present invention can be disposed on a house depending on the location of the practical house structure, such as by wall-hanging or suspending, which are the ways of disposing the present invention on a wall and beneath draining tubes or under eaves. As shown in FIG. 7, the adjustable light casing (9) is disposed on a house through the way of wall-hanging; adjustable light casing (10) is disposed under eaves via suspension method. Thus, a user is able to lift the outer case (2) via an extension hook (11) in order to display the light emitting elements inside the inner case (1). Users lift the outer cases to present the light string structures during important holidays or occasions; otherwise, the outer cases remain closed in order to protect the light emitting elements from deteriorating. In the figure, some of the outer cases are lifted to open, and some are not, that is to say the users have total customization and control over the state of their lights with the cases.

Aside from disposing the present invention beneath eaves, other locations of the house are also viable options. It is fully customizable to the customer's preferences. Accordingly, the ways of connection can also be varied. As it can be seen in the FIG. 7, if the distance between two adjustable light casings (9) is short, a direct connection A is used; angled connection B is the alternative option. Hence, the adjustable light casing is malleable to houses with different dimensions and structures.

Compared to prior arts, the adjustable light casing of the present invention has the following advantages listed below:
1. The present invention can be varied with different holidays or user demands, and does not require constant assembly and disassembly.
2. The present invention has different types of connections and installments that accommodate houses with different categories, dimensions and structures.
3. The present invention requires minimal maintenance and easy dismantlement. Therefore, broken lights can be changed sectionally in order to avoid changing an entire line of lights.
4. The present invention is disposed outdoors with a retractable cover so that it can protect the lights from harmful and uncleanly exterior elements, when not in use, through the application of the retractable cover, the adjustable light casing will have an extended life span.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A adjustable light casing comprising:
an inner case, the wall surface of the inner case being a half-arc surface, a surface corresponding to the half-arc surface being an opened surface, a plurality of closed rings being disposed at two ends of the inner case;
an outer case, the wall surface of the inner case being a half-arc surface, a surface corresponding to the half-arc surface being an opened surface, a plurality of closed rings being disposed at the two ends of the outer case;
a plurality of lateral fastening members, each lateral fastening member having an inner ring structure and an outer ring structure;
wherein the closed rings at the two ends of the inner case are fastened to the inner ring structures of the lateral fastening members and the rings at the two ends of the outer case are movably female-connected with the outer ring structures of the lateral fastening members, the opened surface of the inner case being shielded or opened by the half-arc surface of the outer case while the inner case is turned upwardly.

2. The adjustable light casing according to claim 1, wherein the inner surface of the inner case is disposed at least one lamp-string fixing structure 5 that is to position at least light emitting element.

3. The adjustable light casing according to claim 1, wherein each of the rings of the inner case has a fastening hole, the inner ring structure of the lateral fastening member having a fastening hole corresponding to the fastening hole, the fastening holes of the inner case being corresponding to a fastening hole the inner ring structures of the lateral fastening member and the inner case being female-connected with the inner ring structure through a plurality of bolts while the inner case and the inner ring structures of the lateral fastening members are combined together.

4. The adjustable light casing according to claim 1, wherein the outer ring structure of the lateral fastening member has a stop portion, the location of the inner side of the outer case corresponding to the stop portion has at least one protruding structure in order to let the outer case be female-connected with and slid on the outer ring structure, the lifting of the outer case being stopped while the protruding structure touches the stop portion.

5. A adjustable light casing comprising:
a plurality of lateral fastening members, each lateral fastening member having an inner ring structure and an outer ring structure, a plurality of screw structures being internally disposed in the lateral fastening member;
an inner case, the wall surface of the inner case being a half-arc surface, a surface corresponding to the half-arc surface being an opened surface, a plurality of closed rings being disposed at two ends of the inner case;
an outer case, the wall surface of the inner case being a half-arc surface, a surface corresponding to the half-arc surface being an opened surface, a plurality of closed rings being disposed at the two ends of the outer case; and
a plurality of case-fastening members, which are fastened to the screw structures of the lateral fastening members, so that the case-fastening members are fastened to a roof, ceiling or wall.

6. The adjustable light casing according to claim 5, wherein the case-fastening member comprises a plurality of positioning bases, screw pillars and nuts, the positioning base being constructed by a bottom plate and a stand plate that are perpendicular to each other, wherein the stand plate has a through hole, the screw pillar being through the through hole of the stand plate of the positioning base and then screwed into the screw structure of the lateral fastening member, the nut and the screw pillar being then screwed together in order to bond the positioning base, the lateral fastening member and the inner case together.

7. The adjustable light casing according to claim 6, wherein the bottom plate of the positioning base has at least one connecting hole, the bottom plate of the positioning base being fastened to the roof, ceiling or wall while at least one bolt is through the connecting hole of the bottom plate.

8. The adjustable light casing according to claim 5, wherein each of the rings of the inner case has a fastening hole, the inner ring structure of the lateral fastening member having a fastening hole corresponding to the fastening hole, the fastening holes of the inner case being corresponding to the inner ring structures of the lateral fastening member and the inner case being female-connected with the inner ring structure through a plurality of bolts while the inner case and the inner ring structures of the lateral fastening members are combined together.

9. The adjustable light casing according to claim 5, wherein the outer ring structure of the lateral fastening member has a stop portion, the location of the inner side of the outer case corresponding to the stop portion has at least one protruding structure in order to let the outer case be female-connected with and slid on the outer ring structure, the lifting of the outer case being stopped while the protruding structure touches the stop portion.

10. The adjustable light casing according to claim 5, wherein the positioning base has at least one positioning hole corresponding to one side of the lateral fastening member, the location of the lateral fastening member corresponding to the positioning hole of the positioning base being disposed at least one positioning hole, the opened surface of the inner case being toward an irradiation surface through that an inserting rod is inserted into the positioning base and the positioning hole of the lateral fastening member.
